(19) United States
(12) Patent Application Publication
(10) Pub. No.: US 2008/0187088 A1
(43) Pub. Date: Aug. 7, 2008

(54) TRACK MOUNTED STEAM GENERATOR MAN-WAY RADIATION SHIELD DOOR SYSTEM

(76) Inventor: Earl Jacobson, Huntley, IL (US)

Correspondence Address: MATHEW R. P. PERRONE, JR., 210 SOUTH MAIN STREET, ALGONGUIN, IL, 60102-2639, US

(21) Appl. No.: 11/830,978

(22) Filed: Jul. 31, 2007

Related U.S. Application Data
(63) Continuation-in-part of application No. 11/772,669, filed on Jul. 2, 2007.
(60) Provisional application No. 60/818,424, filed on Jul. 2, 2006.

(51) Int. Cl. G21C 11/00

(52) U.S. Cl. 376/287

(57) ABSTRACT

The invention places adequate and useable shielding in the path of the radiation that exists when nuclear workers perform maintenance and inspection of the Pressure Water Reactor Steam Generator component at a nuclear electric generating plant. The shielding has an upper and a lower track member that permit the two shield assembly halves to roll easily and be manipulated so that access and the associated work to be performed will result in significant reduction to the typical radiation dose that the nuclear workers receive during this work when compared with the current shielding approach. The shielding includes rollers that roll on track members that are located above and below the man-way opening.

### CROSS REFERENCE TO RELATED APPLICATIONS

This application is a continuation in part of U.S. patent application Ser. No. 11/772,669, filed Jul. 2, 2007, said application being based on Provisional Application No. 60/818,424, filed Jul. 2, 2006, both applications being by the same inventor and incorporated herein by reference.

This invention relates to a biological radiation shield apparatus and more particularly to a track mounted, steam generator, man-way radiation shield apparatus that reduces the radiation exposure to the workers as they perform maintenance or inspection of a steam generator, especially the primary heat transfer system of a pressure water reactor (PWR) nuclear electric generating plant.

### BACKGROUND OF THE INVENTION

Routine maintenance or inspection requires the opening of certain ports in the Steam Generator system of a Pressure Water Reactor Nuclear Electric Generating Plant, thereby exposing the workers to significantly increased radiation levels.

### FIELD OF THE INVENTION

This invention relates to the field of apparatus typically defined as “shielding” against radiation in order to reduce the radiation levels and radiation exposure to the workers that are maintaining and/or inspecting Pressure Water Reactor (hereinafter “PWR”) Steam Generator systems. The invention provides an improved apparatus for and method of shielding (reducing the radiation levels through the physics principle of attenuation) while permitting the required maintenance or inspection. The improved shielding specifically addresses the elevated radiation levels that occur when the access ports, commonly called “man-ways”, are opened in order to perform this maintenance and/or inspection.

Most reactors of this type have limited usable shielding. The main requirement that causes a limitation on the amount of shielding that can be utilized is due to the fact that the shielding has to be placed in a plane that is customarily offset approximately 25 degrees from vertical.

Typically, a radiation shield apparatus is heavy so that a radiation shielding panel as a part thereof cannot be easily moved out of the way of the opening. Weight makes it a difficult item to move without having to overcome gravity. Yet, the shield apparatus must be heavy in order to reduce the radiation exposure to nuclear workers. Shield weight or mass in the path of the radiation is directly proportional to the effectiveness of the shielding. The prior art swing door shield system's shielding effectiveness is compromised by the weight that can be safely and easily be manipulated by the workers.

The radiation shield apparatus must also provide adequate shielding while maintaining the necessary functional qualities to workers that are inspecting or maintaining the steam generator component of a pressure water nuclear electric generating plant. It is very desirable to increase the shielding by placing a significant weight or mass in the path of the radiation, while keeping maintenance or inspection accessible. Shielding must be maintained while accessing the port.

The shielding must also be movable in a lateral or manipulated so as to remain between the worker and the radiation source while performing much of the work activity. Yet, again gravity limits the amount of shielding that can be utilized due to the shielding having to be placed in a plane that is customarily offset. Openings or radiation paths that occur with any shield that is hinged from one side and must be manipulated or swung open for access, have to be avoided.

The worker cannot maintain the shield between him and the radiation source(s) and still be able to swing the shield out from in front of the man-way opening in order to have access for lines and hoses leading to robotics equipment for installing repair sleeves to eliminate leaking or failing tubes and other maintenance and inspection equipment.

The existing shielding apparatus has a hinged shield that requires swinging out and away from the man-way port for access and therefore the workers are not able to “hide” behind the shield as they manipulate the maintenance and inspection equipment. Each opening and closing of the shield further exposes the worker to increased radiation levels due to the physical positions that the worker must assume in order to unlock, lock and manipulate this relatively heavy swinging shield door.

By reference to FIG. 2, FIG. 3, FIG. 4, and FIG. 5, a structure of the prior art becomes clear. The man-way 102 has a typical shield 110 mounted thereover. The typical shield 110 includes a heavy hinge 112 supporting a swing door shield 114. Due to tremendous weight of typical shield 110, hinge 112 makes it difficult for swing door shield 114 to provide access for maintenance or repair of the reactor.

In FIG. 5, it becomes clear that worker 124 must juggle a yellow lead blanket panel 120 and to use hoses 310 in order to perform maintenance on the reactor. Prior to doing anything, white lead blankets 122 must be placed around the man-way 102. Thus, this cumbersome procedure indicates a great advantage for any system, which simplifies this procedure.

Another object of the present invention is to address the demands of the Nuclear Regulatory Commission that requires all activities within the Radiological Controlled Area (RCA) be conducted with the goal that the radiation exposure to the nuclear workers be “as low as reasonably achievable” (ALARA).The worker cannot maintain the shield between him and the radiation source(s) and still be able to swing the shield out from in front of the man-way opening in order to have access for lines and hoses leading to robotics equipment for installing repair sleeves to eliminate leaking or failing tubes and other maintenance and inspection equipment.

### SUMMARY OF THE INVENTION

Among the many objectives of the present invention is the provision of a radiation shield apparatus with a track support frame on which at least one shielding assembly can be easily moved out of the way of the opening without having to overcome gravity.

Another objective of the present invention is the provision of a radiation shield apparatus to reduce the radiation exposure to nuclear workers that will substantially overcome the deficiencies of the prior art devices.

Yet another objective of the present invention is to provide adequate shielding while maintaining the necessary functional qualities to workers that are inspecting or maintaining the steam generator component of a pressure water nuclear electric generating plant.

Still another objective of the present invention is to increase the shielding which means placing significant weight or mass in the path of the radiation.

A further objective of the present invention is to be able to maintain the shielding effectiveness while accessing the man-way port.

Yet a further objective of the present invention is the provision of an apparatus to permit the shielding to be moved laterally or manipulated so as to remain between the worker and the radiation source while performing much of the work activity.

A still further objective of the present invention is to eliminate the effects of gravity that limit the amount of shielding that can be utilized due to the shielding having to be placed in a plane that is customarily offset.

Another objective of the present invention is to eliminate the openings or radiation paths that occur with any shield that is hinged from one side and as a result must be manipulated or swung open for access.

Yet another objective of the present invention is to permit the worker to maintain the shield between him and the radiation source(s) and still be able to swing the shield out from in front of the man-way opening in order to have access for lines and hoses leading to robotics equipment for installing repair sleeves to eliminate leaking or failing tubes and other maintenance and inspection equipment.

Still another objective of the present invention is to address the demands of the Nuclear Regulatory Commission that requires all activities within the Radiological Controlled Area (hereinafter “RCA”) be conducted with the goal that the radiation exposure to the nuclear workers be “as low as reasonably achievable” (hereinafter “ALARA”).

In addition, the actual installation process of the shielding material prior to any work or inspection is to be performed, must be considered as part of the total dose impact for the work to be performed and clearly a concern to the facility management and the Nuclear Regulatory Commission (hereinafter “NRC”).

Therefore, being able to implement a track support frame by which the shielding is installed in a low dose area and then moved by means of or on a track support frame of this invention to move the shielding material into position for the maximum radiation dose impact for the work or inspection that is to be performed provides a great advantage. However, such a system is not in the prior art.

It is intended that any other advantages and objects of the present invention that become apparent or obvious from the detailed description or illustrations contained herein are within the scope of the present invention. These and other objectives of the invention (which other objectives become clear by consideration of the specification, claims and drawings as a whole) are met by providing an apparatus for and method of shielding (reducing the radiation levels through the physics principle of attenuation) while permitting the required maintenance or inspection. The improved shielding specifically addresses the elevated radiation levels that occur when the man-ways are opened in order to perform maintenance or inspection.

### BRIEF DESCRIPTION OF THE DRAWINGS

FIG. 1 depicts a block diagram for the radiation shield apparatus 100 of this invention.

FIG. 1 a depicts a second block diagram for the radiation shield apparatus 100 of this invention.

FIG. 2 depicts a perspective view of the man-way 102 of the prior art.

FIG. 3 depicts a perspective view of the cover plate 104 of the prior art.

FIG. 4 depicts a front, top perspective view of swing door shield 114 of the prior art.

FIG. 5 depicts a perspective view of worker 124 protected by yellow lead blanket panels 120 and white lead blankets 122 with the swing door shield 114 of the prior art.

FIG. 6 depicts a perspective view of the radiation shield apparatus 100.

FIG. 7 depicts a perspective view of the track support frame 140.

FIG. 8 depicts a perspective view of top stud bolt assembly 148.

FIG. 9 depicts a perspective, top view of bottom stud bolt assembly 147.

FIG. 10 depicts a front, perspective view of radiation shield apparatus 100 in lock down configuration 179.

FIG. 11 depicts a front, perspective view of track roller stop 170.

FIG. 12 depicts a perspective view of roller 154 on track member 142.

FIG. 13 depicts an exploded view of hinge pin 200.

FIG. 14 depicts a perspective view of hinge pin 200 secured by pin clip 204.

FIG. 15 depicts a perspective view of right side-panel 212 being mounted in position.

FIG. 16 depicts a side perspective view of right adjustable secondary lower shield panel 222.

FIG. 17 depicts a front, perspective view of radiation shield apparatus 100.

FIG. 18 depicts a front, perspective view of radiation shield apparatus 100.

FIG. 19 depicts a front, perspective view of the radiation shield apparatus 100.

FIG. 20 depicts a front, perspective view of the radiation shield apparatus 100.

FIG. 21 depicts a front, perspective view of the radiation shield apparatus 100.

FIG. 22 depicts a front, perspective view of the radiation shield apparatus 100.

FIG. 23 depicts a front, perspective view of the radiation shield apparatus 100.

FIG. 24 depicts a front, phantom view of radiation shield apparatus 100 showing port cover plug 252, safety bars 251, and HEPA port shield adapter 256.

FIG. 25 depicts a front, phantom view of radiation shield apparatus 100 showing port cover plug 252, safety bars 251, and HEPA port shield adapter 256.

FIG. 26 depicts a front view of original version 300 of radiation shield apparatus 100.

FIG. 27 depicts a profile cut-away view of original version 300.

FIG. 28 depicts a profile cut-away view of original version 300.

Throughout the figures of the drawings, where the same part appears in more than one figure of the drawings, the same number is applied thereto.

### DESCRIPTION OF THE PREFERRED EMBODIMENTS

The invention provides an improved apparatus for and method of shielding (reducing the radiation levels through the physics principle of attenuation) while permitting the required maintenance or inspection. The improved shielding specifically addresses the elevated radiation levels that occur when the man-ways are opened in order to perform this maintenance and/or inspection. Moreover, it pertains specifically to an improved shield door system used as a radiation shield apparatus that includes a track system on which a radiation shielding panel or panels can be easily moved out of the way of the opening without having to overcome gravity. The shielding provided by the shield door system has two half shield panels closing the man-way; and that, when moved, can provide partial or full access to the man-way port. Each of the shield panels includes a hinged lower section that can be opened as needed to permit insertion of inspection devices, including robotics and other equipment for the repair and/or inspection of the internals of the Steam Generator. This rolling shield system easily moves (rolls) across the face of the open port on rollers and permits the worker to manipulate the maintenance and/or inspection equipment as needed and still remain completely or partially behind the protective radiation shield.

In view of the limitations now present in the prior art, the present invention provides a new and useful radiation shielding apparatus which reduces the radiation dose received by the workers that are maintaining or inspecting PWR Steam Generator system. The improved shielding specifically addresses the elevated radiation levels that occur when the man-ways, are opened in order to perform this maintenance and/or inspection.

The invention significantly decreases the radiation dose that the workers receive during all phases of work performed in the area of the man-way port. In addition, the effective shielding of the prior art system when fully installed is approximately one-third that of the present invention due to the fact that the face of the port is inclined downward by approximately 25 degrees and the existing shielding must overcome gravity in order to swing the door up and into position.

Even though the invention includes the use of a single door or shield panel assembly that will move laterally on a track member, this description will detail the invention utilizing two doors or shield panel halves, a right half and a left half. The use of a double shield door or panel minimizes the amount of weight of any single component that must be handled by an individual nuclear worker.

Each shielded door panel half of the shield door system has three parts, an upper primary shield panel that includes the rollers, a secondary lower shield panel that is hinged off of the primary shield panel and a side shield that also is attached to the angle steel on the primary shield panel. The assembled shielded door panel weighs significantly more than what can be easily handled and as described above must be assembled in place from three lighter weight component shield panel pieces. All of the shield panels have at least 2.5 centimeters (one inch) thick lead sheet or shielding equivalent to that of 2.5 centimeters (one inch) of lead and are contained in a metal covering such as stainless steel sheeting.

The goal is to improve the shielding quality of the shield which requires placing mass in the path of the radiation. The shield panel halves roll on an upper track that supports the weight and a lower track that maintains the shield at an angle from vertical and in close proximity to the plane of the man-way opening. The track and supporting frame is attached to the sealing surface that is around the man-way opening in the same location the approximately 10.2 centimeters (four inches) thick steel cover that has to be removed from the opening in order to perform the required maintenance and/or inspection. Four of the approximately 20 available stud apertures are used to secure the track support frame to the surface around the man-way opening.

The man-way opening is tipped downward by approximately 25 degrees. The current system utilizes a hinged shield that swings to one side only. The process of opening requires that gravity must be overcome because of the downward tipping and when the shield is swung away from the opening the workers in the area receive a significant amount of radiation exposure. As stated previously, the amount of shielding is compromised in order to keep the weight at a manageable level.

The invention includes two rollers at the top of each half shield assembly that permits easy rolling, even with the necessary weight, on a track which is supported above the man-way opening. A single roller is located at the bottom corner of each shield halves and roll on the underside of the lower track member. All of the weight of each shield assembly halves is carried by the upper track and the two rollers. The lower roller and track simply maintains the shield halves at the approximately 25 degree angle and in close proximity to the face of the man-way opening.

The invention places the shielding halves on a level plain and therefore the amount of weight of the shielding does not impact the ability of a worker to move the shielding as needed for access. The invention reduces the radiation levels directly in front of the shield by a factor of approximately three (3) compared to the existing shielding due directly to the amount of mass in the path of the radiation. In addition, the shielding maybe moved in such as way that access to the man-way opening can often be accomplish while the worker remains behind one of the halves, this benefit cannot be accomplished with the swing door type shielding currently used.

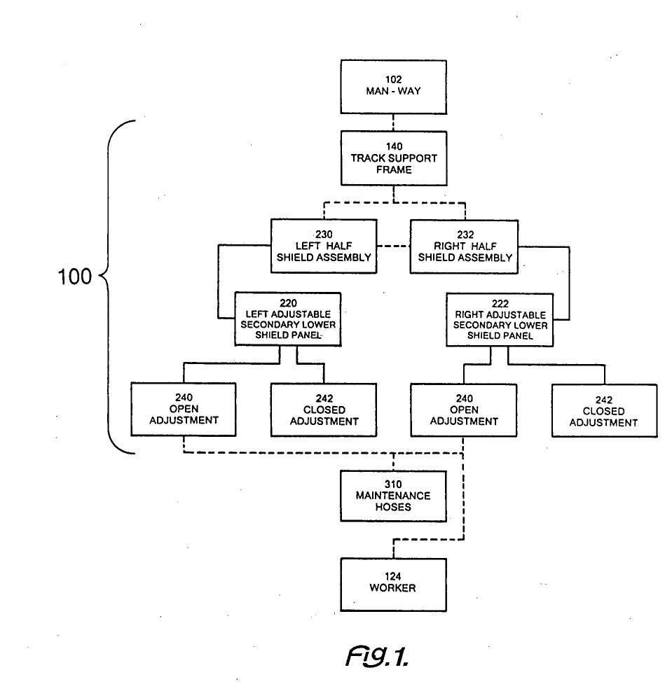

Adding FIG. 1 to the consideration, the structure of radiation shield apparatus 100 can clearly be seen. Radiation shield apparatus 100 covers man-way 102. Radiation shield apparatus 100 has a track support frame 140 (also referred to as a track system) onto which attaches a left half shield assembly 230 (also referred to as a left shield panel, a radiation shielding panel, or a left shield panel assembly) and a right half shield assembly (also referred to as a right shield panel, a radiation shielding panel, or right shield panel assembly) 232 which move across the man-way 102 of the steam generator. Left half shield assembly 230 and right half shield assembly 232 cooperate to open or close man-way 102 as desired.

Left half shield assembly 230 has a left adjustable secondary lower shield panel 220 (also referred to as the left lower hinged panel) which can be in the open adjustment 240 or the closed adjustment 242. Right half shield assembly 232 has a right adjustable secondary lower shield panel 222 (also referred to as the right lower hinged panel) which can be in the open adjustment 240 or the closed adjustment 242. Open adjustment 240 provides access for maintenance hoses 310 and other equipment to be used by worker 124 for maintenance or repair.

Adding FIG. 1a to the consideration, a variation to radiation shield apparatus 100 can be clearly seen. In this embodiment, radiation shield apparatus 100 has a single shield assembly 228 which has a single adjustable secondary lower shield panel 219. The structure and function of this embodiment are otherwise the same as that described in FIG. 1.

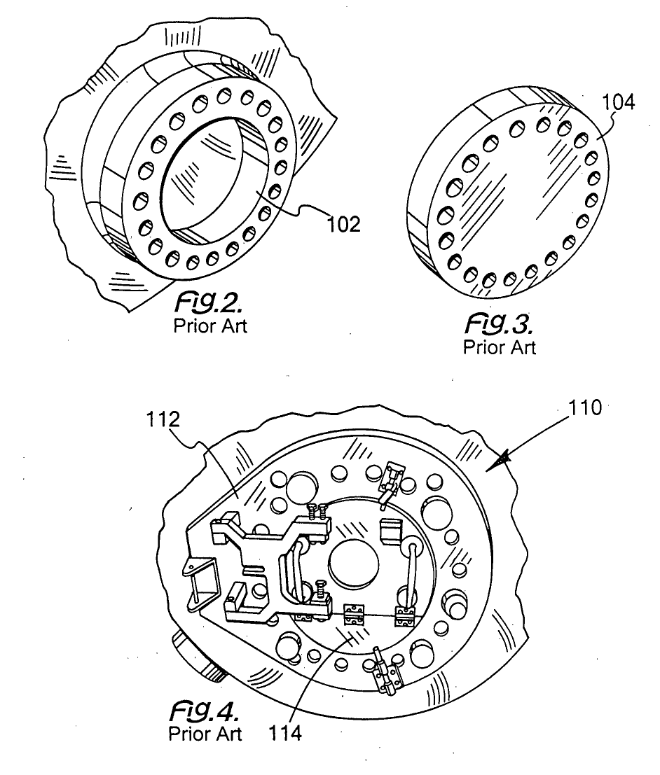

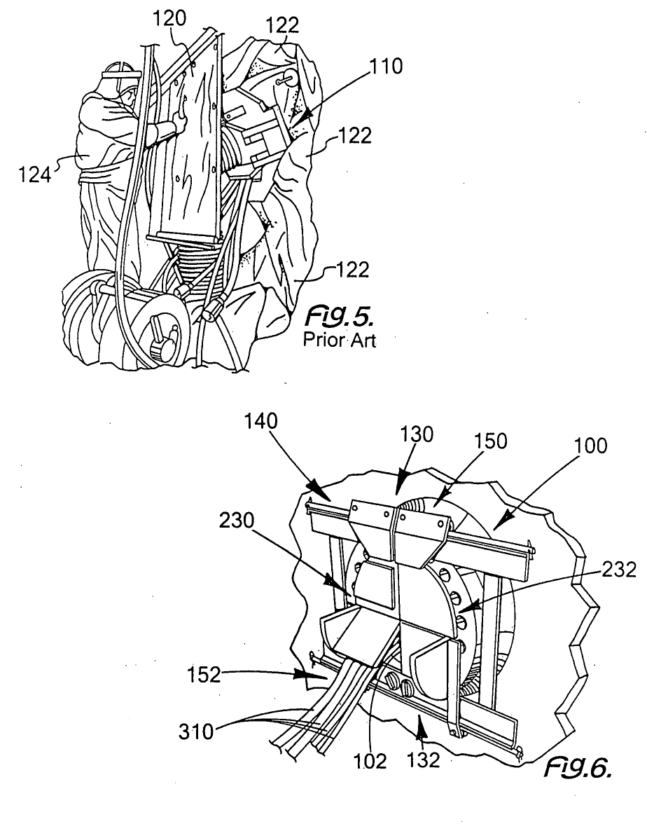

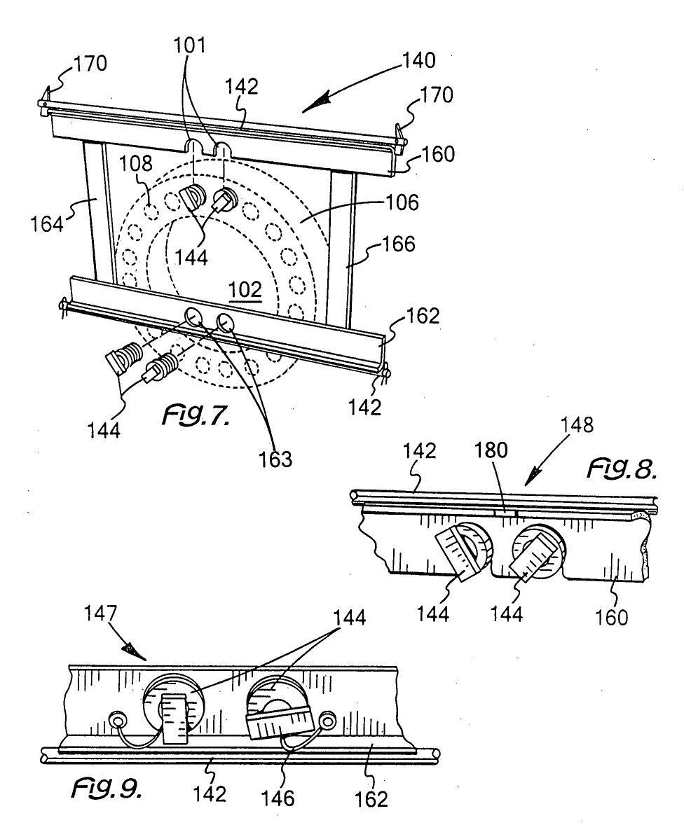

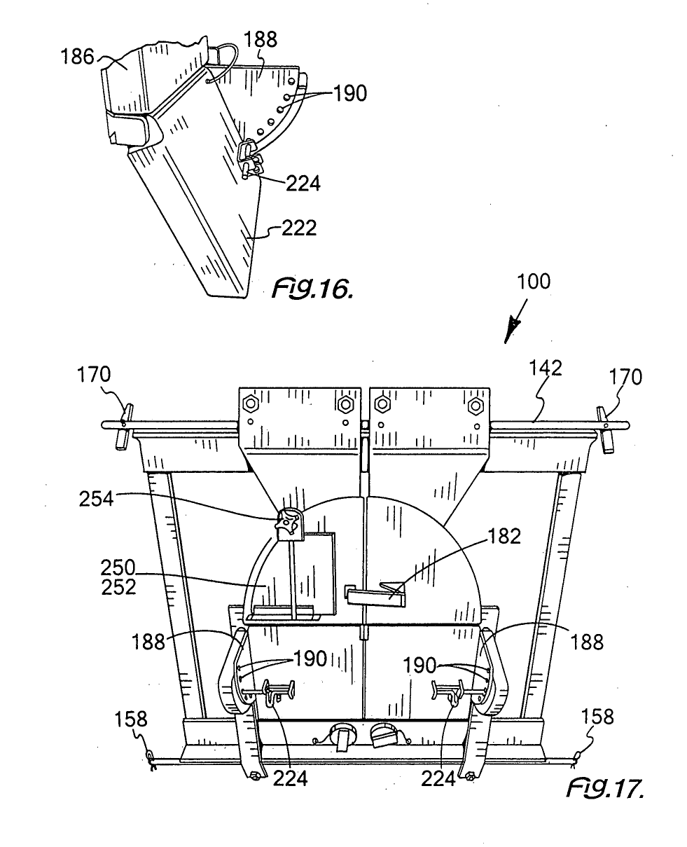

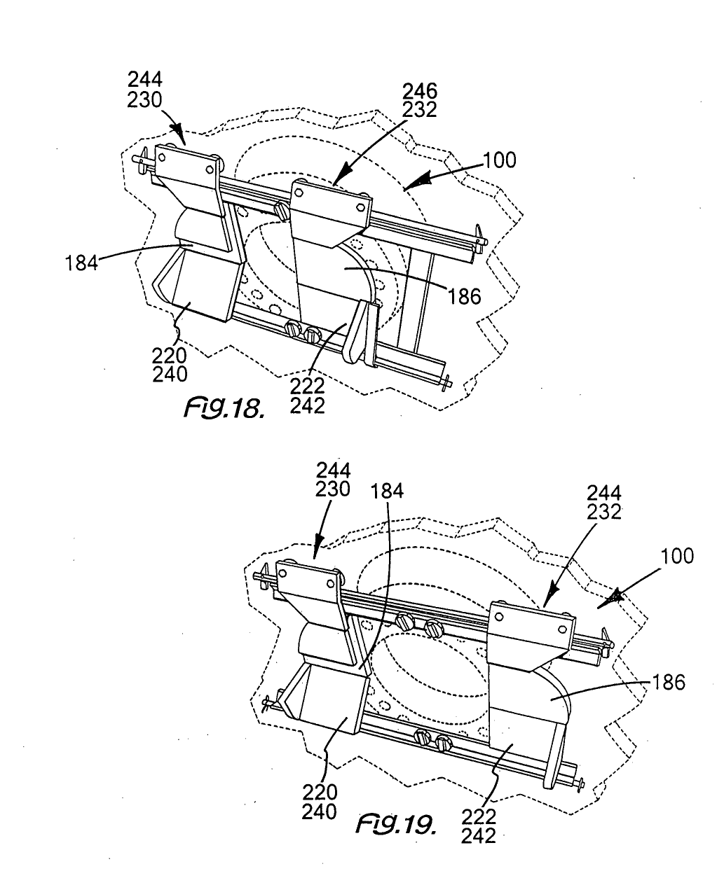

Adding FIG. 2, FIG. 3, FIG. 4, and FIG. 5 to the consideration, the problems and safety concerns of the prior art can be clearly seen. In the prior art, cover plate 104 is removed from man-way 102 and a typical shield 110 is installed. Typical shield 110 is attached to sealing surface 106 in much the same manner as seen in FIG. 7, FIG. 15, FIG. 16, and FIG. 17.

Typical shield 110 has swing door shield 114. Swing door shield 114 is able to swing open through its interaction with hinge 112. Swing door shield 114 swings out and away from man-way 102.

However, swing door shield 114 does not provide adequate protection to workers 124 as discussed in the background of the invention. Thus, to prevent harmful exposure emanating from man-way 102 yellow lead blanket panels 120 and white lead blankets 122 are necessary.

Adding FIG. 6 to the consideration, the structure of radiation shield apparatus 100 which covers man-way 102 becomes clear. The man-way 102 is inclined up to 35 degrees from vertical, with the top portion 130 being outward by that amount relative to bottom portion 132. More preferably, the incline is about 10 degrees to 30 degrees. Most preferably, the incline is 20 degrees to 30 degrees.

Radiation shield apparatus 100 has a left half shield assembly 230 and a right half shield assembly 232. Left half shield assembly 230 and right half shield assembly 232 are attached to track support frame 140 through top support roller assembly 150 and bottom guide roller assembly 152.

Maintenance hoses 310 can be inserted through radiation shield apparatus 100 once it is installed over man-way 102. Maintenance hoses 310 are utilized to clean and perform routine maintenance.

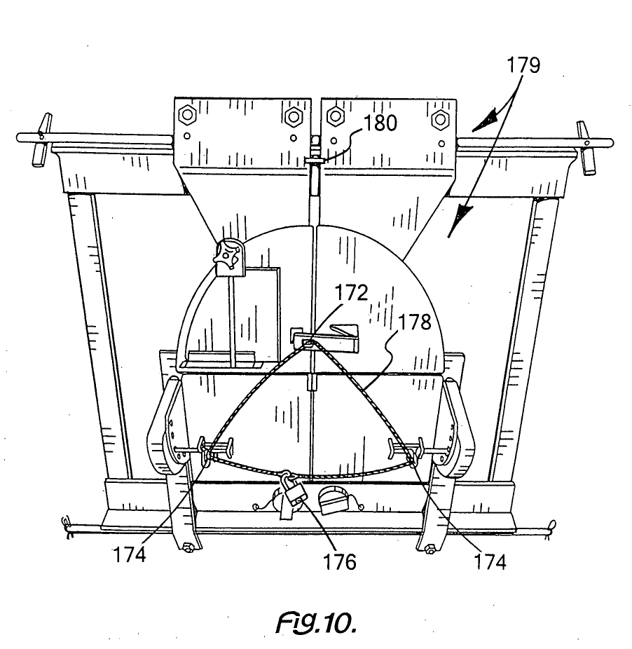

Adding FIG. 7, FIG. 8, and FIG. 9 to the consideration, the structure of track support frame 140 becomes clear. Track support frame 140 is substantially rectangular in shape and has top cross member 160 which is oppositely disposed from bottom cross member 162. Left standing member 164 and right standing member 166 are oppositely disposed from each other and join top cross member 160 and bottom cross member 162. Track support frame 140 mounts over man-way 102 and attaches to sealing surface 106. Track support frame 140 is secured to sealing surface 106 through stud bolts 144.

Once cover plate 104 is removed from man-way 102, stud bolts 144 are securely inserted into stud apertures 108 on sealing surface 106. Track support frame 140 has top cross member 160 which has alignment slots 101. Alignment slots 101 insert over stud bolts 144 to guide the correct and precise positioning of track support frame 140. Once track support frame 140 is correctly positioned, stud bolts 144 are tightened in top cross member 160. Stud bolts 144 are also inserted into bottom apertures 163 and tightened into bottom cross member 162.

Top stud bolt assembly 148 has top cross member 160 and track member 142. Top cross member 160 has track member 142 at a perpendicular plane to man-way 102. Track member 142 has track roller stop 170 on each side to ensure that radiation shield apparatus 100 does not roll over the end of top cross member 160. Upper track member also has push pull center stop lock 180.

Bottom stud bolt assembly 147 had bottom cross member 162 and track member 142 at a perpendicular plane to man-way 102. Bottom cross member 162 has bottom apertures 163 and stud bolts 144. Stud bolts 144 are permanently affixed to bottom cross member 162 through bolt tethers 146.

Now adding FIG. 10 to the consideration, the lock down configuration 179 of radiation shield apparatus 100 can clearly be seen. Lock down configuration 179 creates a lockable high radiation area, which is defined by the Nuclear Regulatory Commission as a high radiation area which is controlled through a locking system.

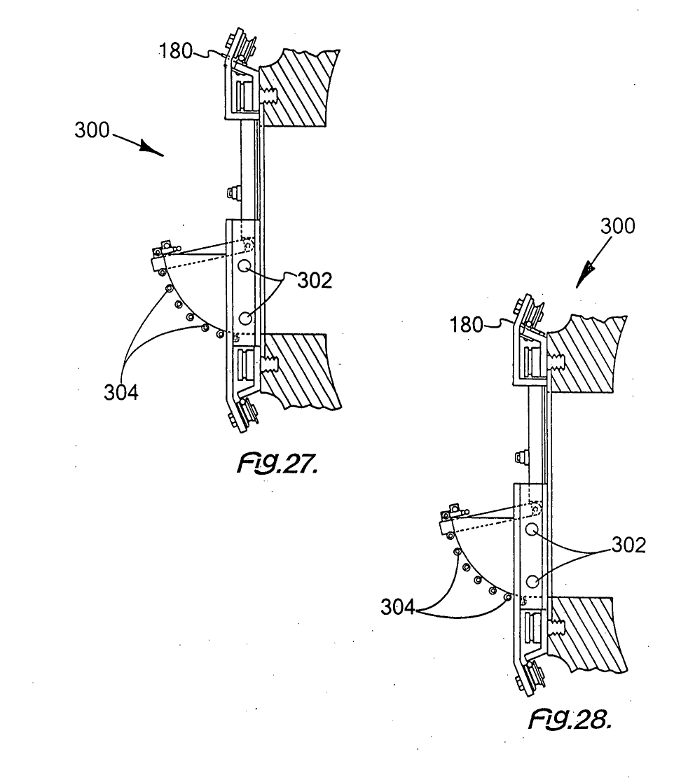

To establish the lock down configuration 179, left half shield assembly 230 and right half shield assembly 232 are separated and push pull center stop lock 180 is moved from backward position and placed forward (also depicted in FIG. 27 and FIG. 28). Then, left half shield assembly 230 and right half shield assembly 232 are pushed together. Push pull center stop lock 180 has two cavities to accommodate the upper portion of left half shield assembly 230 and right half shield assembly 232. Push pull center stop lock 180 stops the movement of left half shield assembly 230 and right half shield assembly 232 toward each other.

Center draw latch 182 (depicted in FIG. 17) has latch lock slot 172. Lockable slide bolts 224 each have slide bolt lock slots 174. Cable 178 threads through latch lock slot 172 and slide bolt lock slots 174 and the ends of cable 178 are securely locked together with pad lock 176.

The workings of push pull center stop lock 180 and cable 178 with pad lock 176 establish lock down configuration 179. Push pull center stop lock 180 prevents either left half shield assembly 230 or right half shield assembly 232 from being moved past the substantially center point on upper track 142 where push pull center stop lock 180 is located. Center draw latch 182, cable 178, and pad lock 176 prevent right half shield assembly 232, left half shield assembly 230 from being opened or moving away from the center toward the left and right ends of upper track support bar 142. Also, cable 178 and pad lock 176 prevent either left adjustable secondary lower shield panel 220 or right adjustable secondary lower shield panel 222 from being adjusted and thus exposing man-way 102.

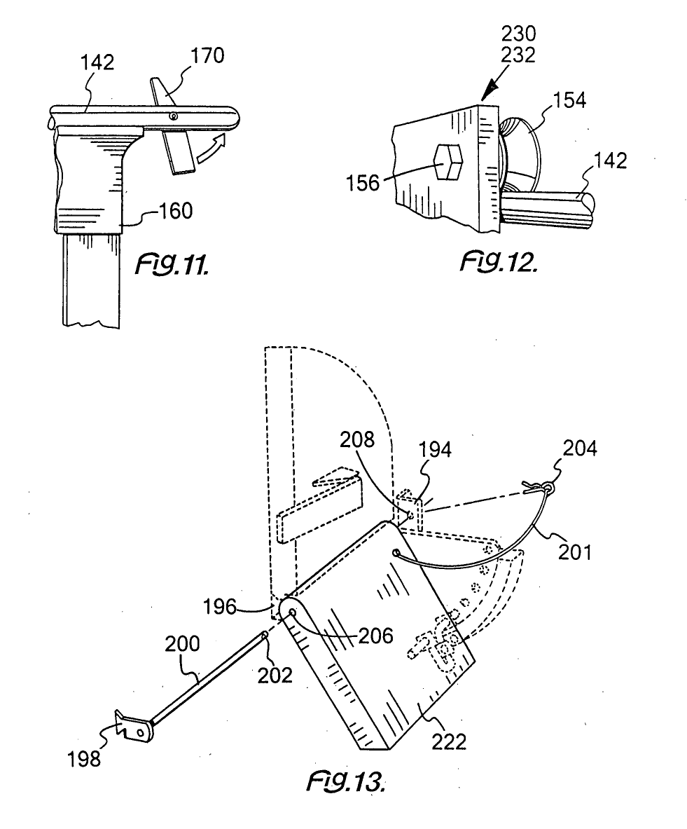

Now adding FIG. 11 and FIG. 12 to the consideration, top support roller assembly 150 and bottom guide roller assembly 152 can be clearly seen. Only top support roller assembly 150 is depicted in these figures but bottom guide roller assembly 152 functions in the same manner. Top support roller assembly 150 has two rollers 154 and track member 142. Bottom guide roller assembly 152 has track member 142 and a single roller 154.

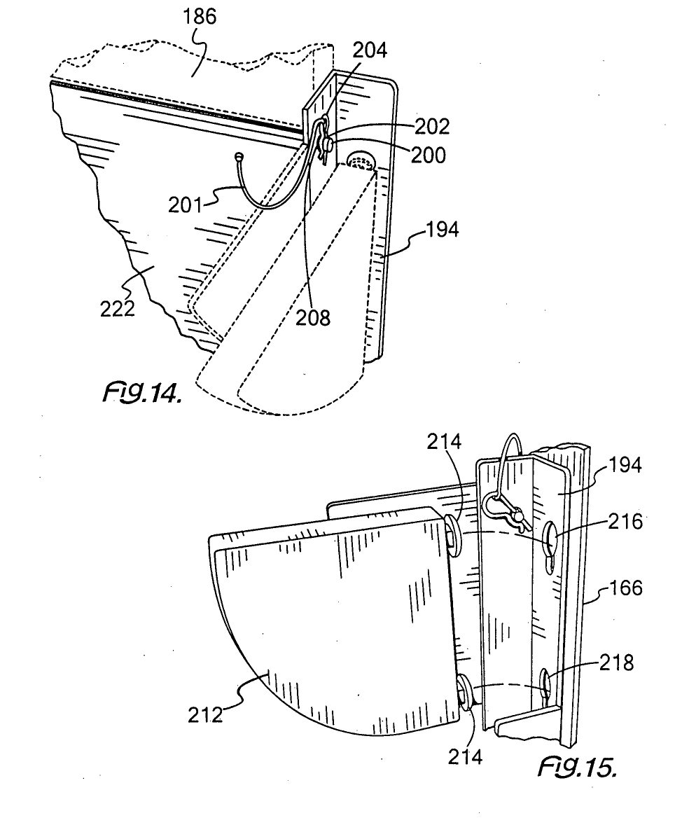

Left half shield assembly 230 and right half shield assembly 232 travel, by means of or on upper and lower rollers 154, on upper and lower track members 142. For the lower track member 142, a single roller 154 is attached to angle steel 194 (depicted in FIG. 13, FIG. 14, and FIG. 15) by roller bolt 156. While a pair of rollers 154 is attached to each the upper portion of left half shield assembly 230 or right half shield assembly 232 by roller bolt 156 in top support roller assembly 150.

Upper track member 142 and lower track member 142 are held perpendicular to man-way 102. The upper portion of left primary shield panel 184 and right primary shield panel 186 are angled about upper track member 142 to allow for this perpendicular alignment. Angle steel 194 is also angled about lower track member 142 to allow for this perpendicular alignment.

Top support roller assembly 150 is designed to support the weight of left half shield assembly 230 and right half shield assembly 232. Bottom guide roller assembly 152 is designed to guide and support the workings of top support roller assembly 150, especially at the desired angle thereby facilitating movement and use of radiation shield apparatus 100. Since the movement of left half shield assembly 230 and right half shield assembly 232 are not offset, the effects of gravity are not as great and thus, it is easier to move heavier shielding.

Now adding FIG. 13 and FIG. 14 to the consideration, the connection between right primary shield panel 186 and right adjustable secondary lower shield panel 222 can be clearly seen. While only the right side is depicted, the left primary shield panel 184 and the left adjustable secondary lower shield panel 220 function in the same manner.

Right adjustable secondary lower shield panel 222 has hinge sleeve 206 which cooperates with dove tail cavity 196 on right primary shield panel 186. Right primary shield panel 186 is welded or otherwise suitably attached to angle steel 194. Hinge sleeve 206 is aligned with hinge end aperture 208 and hinge pin 200 is slid through hinge sleeve 206 and hinge end aperture 208 on angle steel 194 to connect the right adjustable secondary lower shield panel 222 and right primary shield panel 186.

Hinge pin 200 is secured in hinge sleeve 206 through different mechanisms on each end. Dove tail connector 198 cooperates with dove tail cavity 196 to form a secure and stable attachment. Dove tail connector 198 is designed to precisely fit in dove tail cavity 196.

On the other end, hinge pin 200 is secured through the interaction of pin aperture 202 and pin clip 204. Pin clip 204 inserts into pin aperture 202 to prevent hinge pin 200 from sliding horizontally in hinge sleeve 206. Pin tether 201 permanently attaches pin clip 204 to right adjustable secondary lower shield panel 222.

Now adding FIG. 15 to the consideration, the interaction of angle steel 194 and right side-panel 212 can be clearly seen. While only right side-panel 212 is depicted, left side-panel 210 attaches in the same fashion. Angle steel 194 is attached to right primary shield panel 186 through welding or any other suitable attachment mechanism. Angle steel 194 has upper key slot 216 and lower key slot 218.

On right side-panel 212, are a pair of carriage-type bolt heads 214. Carriage-type bolt heads 214 are designed to cooperate with upper key slot 216 and lower key slot 218 to form a secure and releaseable connection between right side-panel 212 and angle steel 194.

Now adding FIG. 16 to the consideration, the adjustability of secondary lower shield panels 220 and 222 can clearly be seen. Left adjustable secondary lower shield panel 220 and right adjustable secondary lower shield panel 222 can be adjusted at a variety of angles in relation to left primary shield panel 184 and right primary shield panel 186.

A depiction of right adjustable secondary lower shield panel 222 is depicted in this figure but left adjustable secondary lower shield panel 220 functions in the same manner. Latch adjustment plate 188 is attached to angle steel 194 (as depicted in FIG. 13). Latch adjustment plate 188 can be welded to angle steel 194 or attached in any other suitable fashion. Lockable slide bolt 224 is attached to right adjustable secondary lower shield panel 222 through any suitable attachment mechanism. Latch adjustment plate 188 has a series of latch apertures 190.

The user positions right adjustable secondary lower shield panel 222 at a desired angle relative to right primary shield panel 186. Then, lockable slide bolt 224 and a desired latch aperture 190 are aligned and lockable slide bolt 224 cooperates to secure the connection. When the angle of right adjustable secondary lower shield panel 222 needs to be changed, lockable slide bolt 224 is removed.

Adding FIG. 17 to the consideration, the structure of radiation shield apparatus 100 becomes more clear. As previously stated (FIG. 7), radiation shield apparatus 100 is mounted on sealing surface 106 through the interaction with track support frame 140. Left half shield assembly 230 and right half shield assembly 232 are mounted in three pieces so that each half can provide additional protection (as described in the background of the invention). First, left primary shield panel 184 and right primary shield panel 186 are mounted on upper track member 142. Then, left side-panel 210 is attached to left angle steel 194 and right side-panel 212 is attached to right angle steel 194 (as depicted in FIG. 15) and left adjustable secondary lower shield panel 220 is attached to left primary shield panel 184 and right adjustable secondary lower shield panel 222 is attached to right primary shield panel 186 (as depicted in FIG. 13 and FIG. 14).

Attaching the three pieces of left half shield assembly 230 and right half shield assembly 232 in this manner provides benefits. First, the entirety of left half shield assembly 230 or right half shield assembly 232 can have greater weight, since each individual piece (primary shield panel 184 or 186, adjustable secondary lower shield panel 220 or 222, or side-panel 210 or 212) can have greater weight. The worker only has to lift one individual piece at a time so each individual piece can be composed of thicker lead thus adding to additional shielding.

Secondly, the pieces can be installed at the outer edges of upper track member 142 and lower track member 142 so that the worker can install the pieces away from the man-way and the radiation exposure. Once, the left half shield assembly 230 and the right half shield assembly 232 are installed they can be rolled along upper track member 142 and lower track member 142 to cover man-way 102 and the worker can be shielded from the radiation from behind left half shield assembly 230 or right half shield assembly 232.

Left half shield assembly 230 and right half shield assembly 232 slide along track member 142 in either direction until their movement is stopped by the opposing half, push pull center stop lock 180 (as depicted in FIG. 11), or a track roller stop 170. On lower track member 142 is release clip 158 which further prevents left half shield assembly 230 or right half shield assembly 232 from sliding off of track member 142. Release clips 158 also function to guide and support shield assembly halves 230 and 232 in case a worker 124 (as depicted in FIG. 1) applies too much force in sliding either along track member 142.

Release clips help to ensure that either right half shield assembly 232 or left half shield assembly 230 maintain their secure and stable position in track member 142.

Left adjustable secondary lower shield panel 220 and right adjustable secondary lower shield panel 222 are secured in the desired angle through their interactions with lockable slide bolt 224 and latch apertures 190 on latch adjustment plate 188 (as described in detail in FIG. 16).

Right half shield assembly 232 and left half shield assembly 230 can be securely but releaseably locked together through center draw latch 182. Center draw latch 182 pulls right half shield assembly 232 and left half shield assembly 230 together and locks them in place.

Left primary shield panel 184 has high efficiency particulate arrestance (hereinafter “HEPA”) port opening 250. As shown in FIG. 17, port cover plug 252 covers HEPA port opening 250. Port cover plug 252 is securely but releaseably held in place through cover plug securing bolt 254.

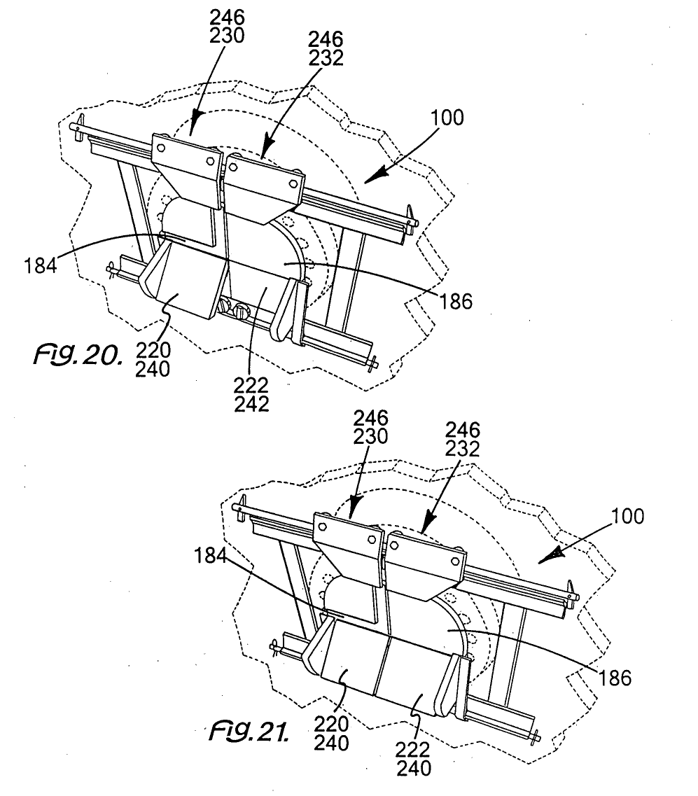

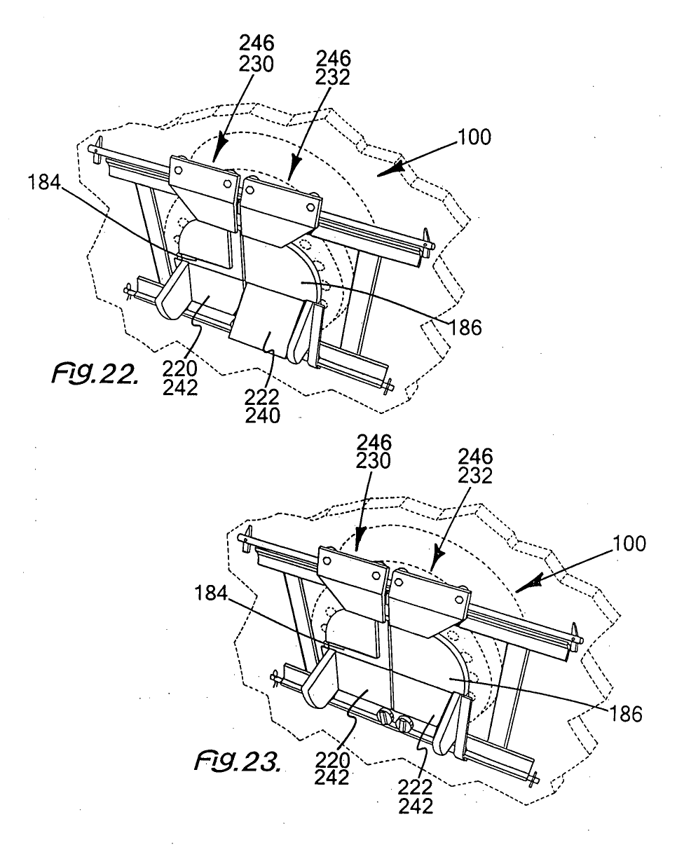

Adding FIG. 18, FIG. 19, FIG. 20, FIG. 21, FIG. 22, and FIG. 23 to the consideration, the flexibility of radiation shield apparatus 100 is seen through the adjustability of secondary lower shield panels 220 and 222 and left half shield assembly 230 and right half shield assembly 232. As depicted in FIG. 11 and FIG. 12, left half shield assembly 230 and right half shield assembly 232 move through top support roller assembly 150 and bottom guide roller assembly 152. As depicted in FIG. 13 and FIG. 16, left adjustable secondary lower shield panel 220 and right adjustable secondary shield panel 222 rotate through its interactions hinge pin 200 and hinge sleeve 206 with and lock through its interactions with latch adjustment plate 188, latch apertures 190, and lockable slide bolt 224.

Referring specifically to FIG. 18, FIG. 19, and FIG. 20, the left half shield assembly 230 and right half shield assembly 232 can be moved into a variety of positions relative to each other. In FIG. 18, left half shield assembly 230 is open 244 exposing man-way 102 while right half shield assembly 232 is closed 246 covering man-way 102. Left primary shield panel 184 travels with left half shield assembly 230 as right primary shield panel 186 remains in place with right half shield assembly 232. Left adjustable secondary lower shield panel 220 is in open adjustment 240 while right adjustable secondary lower shield panel 222 is in closed adjustment 242.

Because left primary shield panel 184 travels with left half shield assembly 230 as right primary shield panel 186 remains in place with right half shield assembly 232, a half slideability is produced. Left primary shield panel 184 may travel independently of right half shield assembly 232. Thus, access is provided to the nuclear reactor 128 for repair or maintenance.

In FIG. 19, both left half shield assembly 230 and right half shield assembly 232 are open 244, fully exposing man-way 102. Left primary shield panel 184 travels with left half shield assembly 230 and right primary shield panel 186 travels with right half shield assembly 232. Left adjustable secondary lower shield panel 220 is in open adjustment 240 while right adjustable secondary lower shield panel 222 is in closed adjustment 242.

In FIG. 20, FIG. 21, FIG. 22, and FIG. 23, both left half shield assembly 230 and right half shield assembly 232 are closed 246 fully covering man-way 102. Left primary shield panel 184 remains in place with left half shield assembly 230 while right primary shield panel 186 remains in place with right half shield assembly 232.

Referring specifically to FIG. 20, FIG. 21, FIG. 22, and FIG. 23, the adjustability of left adjustable secondary lower shield panel 220 and right adjustable secondary lower shield panel 222 can be clearly seen. These panels can be individually or jointly opened or closed through their adjustable interactions as seen in FIG. 13, and FIG. 16.

In FIG. 20 left adjustable secondary lower shield panel 220 is in open adjustment 240 while right adjustable secondary lower shield panel 222 is in closed adjustment 242. In FIG. 21, both right adjustable secondary lower shield panel 222 and left adjustable secondary lower shield panel 220 are in open adjustment 240. In FIG. 22, left adjustable secondary lower shield panel 220 is in closed adjustment 242 while right adjustable secondary lower shield panel 222 is in open adjustment 240. In FIG. 23, both left adjustable secondary lower shield panel 220 and right adjustable secondary lower shield panel 222 are in closed adjustment 242.

Open adjustment 240 permits limited access to man-way 102. This limited access permits the worker to manipulate maintenance and/or inspection equipment to access man-way 102 (as depicted in FIG. 6) and still remain completely or partially behind the protective radiation shield. Adjustable secondary lower shield panels 220 and 222 direct the escaping radiation downward while left side-panel 210 and right side-panel 212 block radiation from escaping from the sides. This combination of limited access, guiding, and blocking significantly reduces the amount of radiation exposure to worker (as depicted in FIG. 1).

Left side-panel 210 and right side-panel 212 may end up as installed in the pieces. Assembling by pieces greatly facilitates the installation of the radiation shield apparatus 100. The combination for the left-side panel 210 and right side panel 212 forms radiation shield apparatus 100.

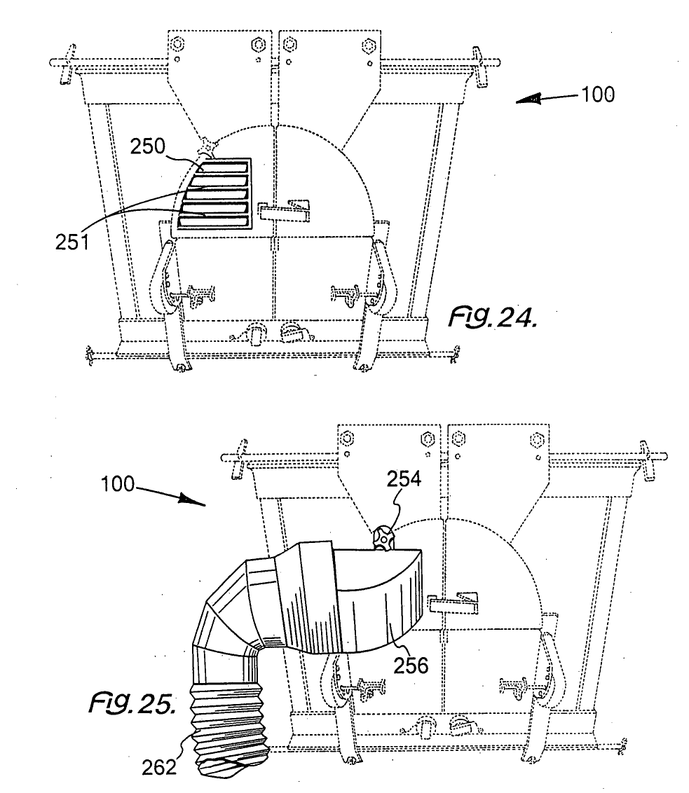

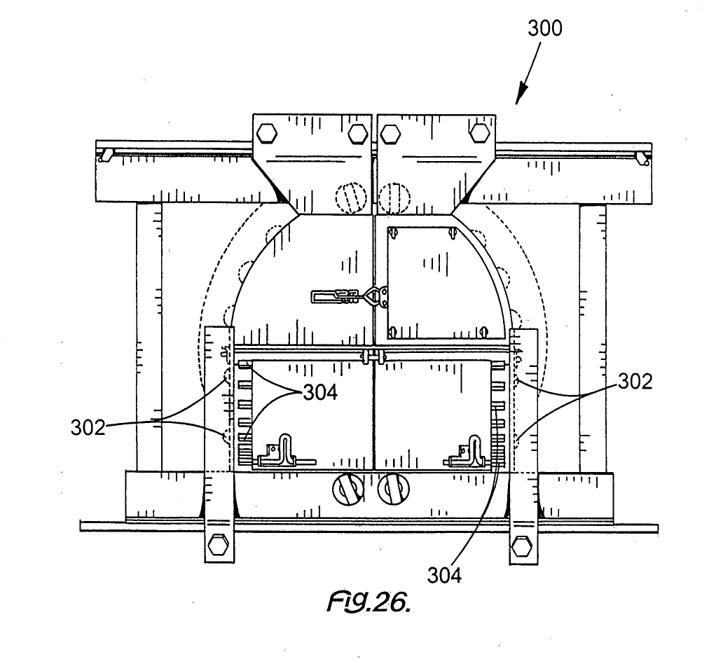

Now adding FIG. 24 and FIG. 25 to the consideration and also considering FIG. 17, various features of radiation shield apparatus 100 can be clearly seen. In FIG. 24, left primary shield panel 184 has HEPA port opening 250 and safety bars 251. HEPA port opening 250 allows radiation and harmful matter to be released from man-way 102. While, safety bars 251 ensure that worker 124 (as depicted in FIG. 1) does not place his hands in the HEPA port opening 250.

In FIG. 25, left primary shield panel 184 has HEPA port shield adapter 256 and flexible ducting 262. These structures are useful in drawing off dangerous radiation while allowing accessibility to the man-way 102. Once radiation passes through HEPA port shield adapter 256 and flexible ducting 262, it safely vents to the environment. HEPA port shield adapter 256 is attached to left primary shield panel 184 through cover plug securing bolt 254.

Now adding FIG. 26, FIG. 27, and FIG. 28 to the consideration, the original version 300 of radiation shield door system can be seen. The major modifications between the present radiation shield apparatus 100 and the original version 300 are latch apertures 190 and right side-panel 212 and left side-panel 210. Latch apertures 190 provide adjustability for adjustable secondary lower shield panels 220 and 222.

First, latch apertures 190 are replaced with outside latch apertures 304. In the embodiment depicted in FIG. 26, FIG. 27, and FIG. 28, outside latch apertures 304 appear in the form of tubes, that are secured to the outer perimeter of right side-panel 212 and left-side panel 210. Whereas in radiation shield apparatus 100, latch apertures 190 are holes that are bored into or otherwise formed in the outer rim of latch adjustment plate 188 (as depicted in FIG. 13 and FIG. 16).

Second, upper key slot 216 and lower key slot 218 are replaced with side mounts 302. In radiation shield apparatus 100, upper key slot 216 and lower key slot 218 are located on the back of right side-panel 212 and left side-panel 210. Where as in the original version 300, the side mounts are located on the inner side of right side-panel 212 and left side-panel 210. The inner side is the side that faces left adjustable secondary lower shield panel 220 or right adjustable 20 secondary lower shield panel 222 once right side-panel 212 and left side-panel 210 are in place. The back mounting of upper key slot 216 and lower key slot 218 makes the left side-panel 210 and right side-panel 212 more flexible in that either left side-panel 210 and right side-panel 212 can be inserted into either side of radiation shield apparatus 100.

This application—taken as a whole with the abstract, specification, claims, and drawings—provides sufficient information for a person having ordinary skill in the art to practice the invention disclosed and claimed herein. Any measures necessary to practice this invention are well within the skill of a person having ordinary skill in this art after that person has made a careful study of this disclosure.

Because of this disclosure and solely because of this disclosure, modification of this tool can become clear to a person having ordinary skill in this particular art. Such modifications are clearly covered by this disclosure.

What is claimed and sought to be protected by Letters Patent is:

1. A radiation shield apparatus for a nuclear reactor for reducing a radiation exposure of a worker as the worker performs maintenance or repair comprising:
a) the radiation shield apparatus being mounted to a track support frame;
b) the radiation shield apparatus having at least one shield assembly;
c) the at least one shield assembly cooperating with the track support frame; and
d) the at least one shield assembly forming a shield from the radiation.

2. The radiation shield apparatus of claim 1 further comprising:
a) the track support frame having a top cross member and a bottom cross member;
b) the top cross member and the bottom cross member securing the radiation shield apparatus to a sealing surface of a man-way of the nuclear reactor;
c) the track support frame having an upper track member, a lower track member, and a roller assembly;
d) the roller assembly cooperating with the at least one shield assembly to allow the at least one shield assembly to roll along the upper track member and the lower track member to open or close access to the man-way; and
e) the rolling shield assembly permitting the worker to manipulate a repair device, a maintenance hose, or an inspection device as needed while remaining completely or partially covered by the shield assembly.

3. The radiation shield door system of claim 2 further comprising:
a) the at least one shield assembly having a primary shield panel, an adjustable secondary lower shield panel, and a left side-panel and a right side-panel;
b) the adjustable secondary lower shield panel being connected to the primary shield panel by a hinge;
c) the hinge permitting the adjustable secondary lower shield panel to be positioned at a variety of angles relative to the primary shield panel;
d) one of the variety of angles permitting the adjustable secondary lower shield panel to completely close access to the man-way; and
e) one of the variety of angles permitting the adjustable secondary lower shield panel to allow access to the man-way to allow the workers to perform inspection or maintenance.

4. The radiation shield apparatus of claim 3 further comprising:
a) the primary shield panel, the adjustable secondary lower shield panel, and the right side-panel and the left side-panel being mounted individually to the track support frame so as to minimize a weight of any single component that must be handle by the individual worker;
b) the primary shield panel being mounted to the top cross member;
c) the adjustable secondary lower shield panel being mounted through a hinge to the primary shield panel;
d) the left side-panel being mounted to a left angle steel and the right side-panel being mounted to a right angle steel; and
e) the shield assembly having a shielding equivalent to an at least 2.5 centimeters thick sheet of lead and being covered by a metal.

5. The radiation shield apparatus of claim 4 further comprising:
a) the primary shield panel having a HEPA port opening to filter an air as it exits the man-way;
b) the HEPA port opening having a flexible ducting to permit the air to vent from the man-way into an environment;
c) the primary shield panel having a port cover plug to cover the HEPA port opening; and
d) a cover plug securing bolt releasably securing the port cover plug to the primary shield panel.

6. The radiation shield apparatus of claim 5 further comprising:
a) the upper track member having a track roller stop on a left end and a right end to prevent the shield assembly from sliding over a right edge or a left edge of the upper track member;
b) the lower track member having a release clip on the left end and the right end to prevent the shield assembly from sliding over the right edge or the left edge of the lower track member;
c) the top cross member and the bottom cross member securing the track support frame to the sealing surface of the man-way;
d) the bottom cross member having at least one bottom aperture which cooperates with at least one stud aperture on the sealing surface to receive at least one stud bolt;
e) the top cross member having at least one alignment slot which cooperates with at least one stud aperture on the sealing surface to receive at least one stud bolt; and
f) the stud bolts securing the track support frame to the sealing surface.

7. The radiation shield apparatus of claim 6 further comprising:
a) the adjustable secondary lower shield panel being secured in the variety of angles relative to the primary shield panel through at least one lockable slide bolt;
b) at least one latch aperture being contained on a latch adjustment plate; and
c) the at least one lockable slide bolt inserting into one of the at least one latch apertures.

8. The radiation shield apparatus of claim 7 further comprising:
a) the roller assembly compromising a top support roller assembly and a bottom guide roller assembly;
b) the top support roller assembly having at least one roller which cooperates with the upper track member;
c) the bottom guide roller assembly having the at least one roller which cooperates with the bottom track support member;
d) the top support roller assembly and the upper track member being capable of supporting a weight of the shield assembly; and
e) the bottom guide roller assembly and the lower track member cooperating with the top support roller and the upper track member to guide the movement and maintain a position of the shield assembly.

9. The radiation shield apparatus of claim 8 further comprising:
a) the left angle steel and the right angle steel being attached to the primary shield panel; and
b) the latch adjustment plate being attached to the left angle steel and the right angle steel.

10. The radiation shield apparatus of claim 9 further comprising:
a) the top cross member and the bottom cross member being connected through a left standing member and a right standing member; and
b) the top cross member, the bottom cross member, the right standing member, and the left standing member forming a substantially rectangular shape.

11. The radiation shield apparatus of claim 10 further comprising:
a) the left angle steel and the right angle steel having an upper key slot and a lower key slot;
b) the left side-panel and the right side-panel including a pair of carriage-type bolt heads; and
c) the pair of carriage-type bolt heads cooperating with the upper key slot and the lower key slot in order to form a secure and releaseable connection between the left side-panel and the left angle steel and the right side-panel and the right angle steel, respectively.

12. The radiation shield apparatus of claim 11 further comprising:
a) the upper track member and the lower track member being substantially perpendicular to the man-way;
b) a face of the man-way being inclined downwardly at an angle from the horizontal of up to 35 degrees;
c) the left angle steel and the right angle steel being angled in such a manner as to allow the perpendicular position of the lower track member in relation to the man-way; and
d) the upper portion of the primary shield panel being bent in such a manner as to allow the perpendicular position of the upper track member to the man-way.

13. The radiation shield assembly of claim 12 further comprising:
a) the perpendicular position of the upper track member in relation to the man-way permitting the shield assembly to be more easily moved;
b) the upper track member and the lower track member being perpendicular in relation to the man-way; and
c) the perpendicular position of the upper track member in relation to the man-way reducing the effect of gravity on the shield assembly.

14. The radiation shield assembly of claim 13 further comprising:
a) the primary shield panel having a dove tail cavity to accommodate the adjustable secondary lower shield panel;
b) the adjustable secondary lower shield panel having a hinge sleeve which accommodates a hinge pin with a dove tail connector and a pin aperture;
c) the left angle steel and the right angle steel being attached to the primary shield panel which has a hinge end aperture;
d) the dove tail connector cooperating with the hinge end aperture and the hinge end sleeve to form a pivotal attachment; and
e) the pivotal attachment being secured by a pin clip.

15. The radiation shield apparatus of claim 14 further comprising:
a) the shield assembly being a left half shield assembly and a right half shield assembly;
b) the left half shield assembly and the right half shield assembly being similar in structure;
c) the adjustable secondary lower shield panel being a right adjustable secondary lower shield panel and a left adjustable secondary lower shield panel;
d) the left half shield assembly and the right half shield assembly being able to roll in a same direction or an opposite direction along the upper track member and the lower track member to open or close access to the man-way;
e) the primary shield panel being a right primary shield panel and a left primary shield panel; and
f) the left half shield assembly and the right half shield assembly being secured together to close the man-way through a center draw latch.

16. The radiation shield apparatus of claim 15 further comprising:
a) the right primary shield panel and the left primary shield panel each having the at least one roller at an upper end;
b) the right angle steel on the right primary shield panel and the left angle steel on the left primary shield panel each having the at least one roller on a lower end;
c) the left half shield assembly and the right half shield assembly being capable of rolling in a same direction or opposite direction of each other;
d) the left half shield assembly being capable or remaining in place while the right half shield assembly rolls along the track support frame;
e) the right half shield assembly being capable of remaining in place while the left half shield assembly rolls along the track support frame;
f) the left adjustable secondary lower shield panel being capable of being in an open adjustment position while the right adjustable secondary lower shield panel is in the open adjustment or a closed adjustment position;
g) the left adjustable secondary lower shield panel being capable of being in the closed adjustment position while the right adjustable secondary lower shield panel is in the open adjustment or the closed adjustment position;
h) the right adjustable secondary lower shield panel being capable of being in the open adjustment position while the left adjustable secondary lower shield panel is in the open adjustment or the closed adjustment position; and
i) the right adjustable secondary lower shield panel being capable fo being in the closed adjustment position while the left adjustable secondary lower shield panel is in the open adjustment or the closed adjustment position.

17. The radiation shield apparatus of claim 16 further comprising:
a) the top cross member having a push pull center stop lock mounted substantially in a center of a top cross member;
b) the push pull center stop lock being positionable in the upper track member which stops the left half shield assembly and the right half shield assembly from contacting each other or traveling an entire length of the upper track member;
c) the push pull center stop lock being positionable away from the upper track member which allows the left half shield assembly and the right half shield assembly to travel the entire length of the upper track member;
d) a left angle steel and a right angle steel each having the upper key slot and the lower key slot;
e) the right side-panel and the left side-panel each including a pair of carriage-type bolt heads; and
f) the pair of carriage-type bolt heads cooperating with the upper key slot and the lower key slot on the left angle steel and the right angle steel in order to form a secure and releaseable connection between the left side-panel and the right side-panel and the left angle steel and the right angle steel.

18. A radiation shield apparatus for a nuclear reactor for reducing a radiation exposure of a work as the worker performs maintenance or repair comprising:
a) a shield assembly being a left half shield assembly and a right half shield assembly;
b) the left half shield assembly and the right half shield assembly being able to roll in a same direction or in an opposite direction along the upper track member and the lower track member;
c) the left half shield assembly and the right half shield assembly being secured together to close the man-way through a center draw latch; and
d) the radiation shield apparatus being capable of being secured in a lock down configuration.

19. The radiation shield apparatus of claim 18 further comprising:
a) the top cross member having the push pull center stop lock which receives the left half shield assembly and the right half shield assembly and prevents them from rolling together on the upper track member;
b) the center draw latch having a latch lock slot;
c) the at least one lockable slide bolt having a slide bolt lock slot;
d) a cable inserting though the latch lock slot and the at least one lockable slide bolt to prevent the center draw latch from being released; and
e) the cable having a first end and a second end and the first end and the second end being secured together through a pad lock.

20. A method for reducing a radiation exposure of a worker as the worker performs maintenance or repair on a nuclear reactor comprising:
a) removing a cover plate from a man-way of a nuclear reactor and exposing at least one stud aperture on a sealing surface;
b) providing a track support frame with a top cross member, a bottom cross member, an upper track member, and a lower track member, with the top cross member having at least one alignment slot and the bottom cross member having at least one bottom aperture;
c) securing at least one stud bolt in the at least one stud aperture;
d) aligning the at least one alignment slot over the at least one stud bolt and firmly tightening the stud bolt in the at least one stud aperture;
e) aligning the at least one stud bolt with the at least one bottom aperture and tightening the at least one stud bolt;
f) attaching a right primary shield panel and a left primary shield panel with each having at least one roller to the top cross member with the at least one roller cooperating with the upper track member at an outer left edge and an outer right edge of the upper track member;
g) providing a right angle steel and a left angle steel with the left angle steel securing to the left primary shield panel and the right angle steel securing to the right primary shield panel and each of the angle steels having the roller which cooperates with the lower track member;
h) attaching a left side-panel and a right side-panel to the right angle steel and the left angle steel respectively;
i) pivotally attaching a left adjustable secondary lower shield panel and a right adjustable secondary lower shield panel to the left primary shield panel and the right primary shield panel, respectively; and
j) sliding a completed left half shield assembly and a right half shield assembly over the man-way with the working staying behind the left half shield assembly and the right half shield assembly.
